(19) United States
(12) Patent Application Publication
(10) Pub. No.: US 2026/0264066 A1
(43) Pub. Date: Sep. 10, 2026

(54) METHODS FOR FORMING ZEOLITE-Y

(71) Applicant: Saudi Arabian Oil Company, Dhahran (SA)

(72) Inventors: Faisal Alotaibi, Al-Khobar (SA); Hana Habboubi, Al-Khobar (SA); Lianhui Ding, Dhahran (SA); Anas Al-Aqeeli, Dhahran (SA); Faisal M. Almulla, Dhahran (SA)

(73) Assignee: Saudi Arabian Oil Company, Dhahran (SA)

(21) Appl. No.: 19/072,015

(22) Filed: Mar. 6, 2025

(51) Int. Cl. B01J 29/08; B01J 35/40; B01J 35/61; B01J 35/63; B01J 35/64; B01J 37/00; B01J 37/02; B01J 37/03; B01J 37/04; B01J 37/06; B01J 37/08; C01B 39/24

(52) U.S. Cl. CPC B01J 29/084; B01J 35/40; B01J 35/615; B01J 35/617; B01J 35/635; B01J 35/647; B01J 37/009; B01J 37/0236; B01J 37/031; B01J 37/04; B01J 37/06; B01J 37/08; C01B 39/24; C01P 2004/03; C01P 2004/04; C01P 2004/62; C01P 2006/12; C01P 2006/14; C01P 2006/16

(57) ABSTRACT

A method of forming zeolite-Y comprises forming a first zeolite precursor solution comprising an alumina source material, a silica source material, and a solvent. The first zeolite precursor solution is aged and combined with a formed second zeolite precursor solution comprising the alumina source material, the silica source material, and the solvent, to form a third zeolite precursor solution. The method includes mixing the third zeolite precursor solution for a time period from 5 minutes to 60 minutes to form a first intermediate mixture, adding a surfactant agent to the first intermediate mixture to form a second intermediate mixture, mixing the second intermediate mixture for a time period from 5 minutes to 60 minutes to form a third intermediate mixture, and heating the third intermediate mixture at a temperature from 50° C. to 150° C. for a time period from 80 hours to 160 hours to form the zeolite-Y.

### FIELD

The embodiments described herein generally relate to porous materials and, more particularly, to zeolites.

### BACKGROUND

Materials that include pores, such as zeolites, may be utilized in petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types and where specific zeolitic materials may be more specifically identified by various names such as zeolite-Y.

### SUMMARY

As described in detail herein, it has been discovered that zeolite-Y may be formed by a process that utilizes a first zeolite precursor solution that is aged and a second zeolite precursor solution that is not aged. According to embodiments, these two precursor solutions may be combined into a third zeolite precursor solution with a surfactant agent to form a zeolite-Y composition. It is believed that, according to one or more embodiments, the aged zeolite precursor solution may form “seeds” that enhance zeolite-Y production and/or properties as compared with conventional fabrication methods. Such produced zeolites may, in some embodiments, have particularly good catalytic functionality for hydrocarbon conversion.

According to one or more embodiments, a method of forming zeolite-Y comprises forming a first zeolite precursor solution comprising an alumina source material, a silica source material, and a solvent; aging the first zeolite precursor solution at a temperature from 15° C. to 45° C. for a time period of from 24 hours to 96 hours to form an aged first zeolite precursor solution; forming a second zeolite precursor solution comprising the alumina source material, the silica source material, and the solvent, forming a third zeolite precursor solution comprising the aged first zeolite precursor solution and the second zeolite precursor solution, wherein the second zeolite precursor solution is not aged such that the alumina source material, the silica source material, and the solvent in the second zeolite precursor solution are not all in contact with one another for more than 24 hours before being combined with the aged first zeolite precursor solution; mixing the third zeolite precursor solution for a time period from 5 minutes to 60 minutes to form a first intermediate mixture; adding a surfactant agent to the first intermediate mixture to form a second intermediate mixture; mixing the second intermediate mixture for a time period from 5 minutes to 60 minutes to form a third intermediate mixture; and heating the third intermediate mixture at a temperature from 50° C. to 150° C. for a time period from 80 hours to 160 hours to form the zeolite-Y.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the claims.

### BRIEF DESCRIPTION OF THE DRAWINGS

The following detailed description of specific embodiments of the present disclosure can be best understood when read in conjunction with the following drawings in which:

FIG. 1 is a Scanning Electron Microscopy (SEM) analysis image with a scale bar of 0.5 micrometers showing the surface properties of a formed zeolite-Y, according to one or more embodiments described herein;

FIG. 2 is a SEM analysis image with a scale bar of 0.5 micrometers showing the surface properties of a conventionally formed zeolite-Y;

FIG. 3 is a Transmission electron microscopy (TEM) analysis image with a scale bar of 200 nanometers showing the crystalline structure of a formed zeolite-Y, according to one or more embodiments described herein;

FIG. 4 is a TEM analysis image with a scale bar of 20 nanometers showing the crystalline structure of a formed zeolite-Y, according to one or more embodiments described herein;

FIG. 5 is a TEM analysis image with a scale bar of 500 nanometers showing the crystalline structure of a conventionally formed zeolite-Y;

FIG. 6 is a TEM analysis image with a scale bar of 50 nanometers showing the crystalline structure of a conventionally formed zeolite-Y;

FIG. 7 is a plot of an adsorption capacity (e.g., y-axis, volume adsorbed (mL/g)) versus a relative pressure P/P⁰ (x-axis) of a formed zeolite-Y, according to one or more embodiments described herein; and

FIG. 8 is a plot of an adsorption capacity (e.g., y-axis, volume adsorbed (mL/g)) versus a relative pressure P/P⁰ (x-axis) of a conventionally formed zeolite-Y.

### DETAILED DESCRIPTION

One or more embodiments presently described herein are directed to methods of making zeolite-Y. The methods are described in detail hereinafter, along with the properties and physical characteristics of the formed zeolite-Y. Conventional methods of forming zeolite-Y may produce zeolite-Y with poor mesoporosity and crystallinity and a relatively large particle size. Thus, conventionally made zeolite-Y may have poor catalytic performance because they may have poor hydrothermal stability and selectivity due to their mesoporosity, crystallinity, and relatively large particle size. Accordingly, as described herein, it has been discovered that methods of forming zeolite-Y, including forming a first zeolite precursor solution, forming a second zeolite precursor solution, and forming a third zeolite precursor solution comprising the first and second zeolite precursor solutions, may allow for the formation of zeolite-Y with superior properties as compared with zeolite-Y formed through conventional methods. Surprisingly, for such methods, it has been presently discovered that zeolite-Y formed by such methods may have a good ratio of a mesopore surface area to a total surface area, for example, at least 30%, a desirable crystallinity, for example, greater than or equal to 60%, and a relatively small particle size, for example, less or equal to than 400 nm.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein.

As described herein, the zeolites formed are zeolite-Y. Zeolite-Y generally comprises an FAU framework type. Zeolite-Y described herein may be characterized, in some embodiments, as ultra-stable zeolite-Y (USY). As used herein, “zeolite-Y” and “USY” refer to a zeolite having a FAU framework type according to the IZA zeolite nomenclature and consisting majorly of silica and alumina, as would be understood by one skilled in the art.

According to the methods for making zeolite-Y described herein, in general, a first zeolite precursor solution having a first ratio of an alumina source material, a silica source material, and a solvent may be formed. The first zeolite precursor solution may be aged to form an aged first zeolite precursor solution. Separately, a second zeolite precursor solution may be formed with a second, different ratio of the alumina source material, the silica source material, and the solvent. A third zeolite precursor solution may be formed by combining the aged first zeolite precursor solution with the second zeolite precursor solution. The third zeolite precursor solution may be mixed to form a first intermediate mixture. A surfactant agent may be added to the first intermediate mixture to form a second intermediate mixture. The second intermediate mixture may be mixed to form a third intermediate mixture. The third intermediate mixture may then be heated in a heating step to form the zeolite-Y.

As described hereinabove, in one or more embodiments, a first zeolite precursor solution, a second zeolite precursor solution, and a third zeolite precursor solution are formed. Generally, zeolite precursor solutions may refer to those that include the materials that will form the zeolite, such as silicon, aluminum, and oxygen atoms. The first zeolite precursor solution, the second zeolite precursor solution, and the third zeolite precursor solution may each include a particular ratio of an alumina source material, a silica source material, a solvent, and/or additional components, as discussed herein. Accordingly, the methods of forming each of the first zeolite precursor solution, the second zeolite precursor solution, and the third zeolite precursor solution may be unique.

Without limitation, the alumina source materials may comprise one or more of elemental aluminum, NaAlO₂, Al₂(SO₄)₃, Al(NO₃)₃, AlCl₃. Al₂O₃, and C₉H₂₁O₃Al. Also, without limitation, the silica source material may comprise one or more of Na₂SiO₃, colloidal silica, fumed silica, and tetraethyl orthosilicate. It should be understood that molecules of the alumina and silica source materials may disassociate in a solution; for example, an intermediate solution may be formed in the process of making one or more of the zeolite precursor solutions. Accordingly, as used throughout this disclosure, when referring to a zeolite precursor solution as “comprising” an alumina source material and/or a silica source material, it generally refers to the zeolite precursor solution comprising the initial molecules of the source materials (e.g., alumina and silica) and/or disassociated components of the source materials. The solvent may be water, but other solvents are not necessarily excluded from the scope of the presently disclosed methods.

As described herein, in the method for forming zeolite-Y described herein, a first zeolite precursor solution is formed. In one or more embodiments, the first zeolite precursor solution may be prepared by mixing a basic compound, the alumina source material, and the solvent to form a first intermediate alumina mixture. Without limitation, the basic compound may be chosen from one or more of NaOH, KOH, Mg(OH)₂; however, the basic compound composition is not necessarily limited to the listed compounds. The ordering of the mixing of the basic compound, the alumina source material, and the solvent is not necessarily limited. For example, the basic compound may be mixed into a solution of the alumina source material and the solvent, the alumina source material may be mixed into a solution of the basic compound and the solvent, or the solvent may be mixed into a solution of the basic compound and the alumina source material.

The silica source material may be added to the first intermediate alumina mixture and mixed for a time period of at least 10 minutes to form the first zeolite precursor solution. For example, and without limitation, the combined silica source material and the first intermediate alumina mixture may be mixed for at least 15 minutes, at least 20 minutes, at least 25 minutes, or even at least 30 minutes.

In one or more embodiments, the basic compound may comprise from 1 wt. % to 10 wt. % of the first zeolite precursor solution, based on the total weight of the first zeolite precursor solution. For example, and without limitation, the first zeolite precursor solution may include the basic compound in an amount, based on the total weight of the first zeolite precursor solution, from 1 wt. % to 3 wt. %, from 3 wt. % to 6 wt. %, from 6 wt. % to 10 wt. %, or any and all sub-ranges formed from any of these endpoints.

In one or more embodiments, the alumina source material may comprise from 1 wt. % to 10 wt. % of the first zeolite precursor solution, based on the total weight of the first zeolite precursor solution. For example, and without limitation, the first zeolite precursor solution may include the alumina source material in an amount, based on the total weight of the first zeolite precursor solution, from 1 wt. % to 3 wt. %, from 3 wt. % to 6 wt. %, from 6 wt. % to 10 wt. %, or any and all sub-ranges formed from any of these endpoints.

In one or more embodiments, the solvent may comprise from 40 wt. % to 70 wt. % of the first zeolite precursor solution, based on the total weight of the first zeolite precursor solution. For example, and without limitation, the first zeolite precursor solution may include the solvent in an amount, based on the total weight of the first zeolite precursor solution, from 40 wt. % to 50 wt. %, from 50 wt. % to 60 wt. %, from 60 wt. % to 70 wt. %, or any and all sub-ranges formed from any of these endpoints.

In one or more embodiments, the silica source material may comprise from 20 wt. % to 50 wt. % of the first zeolite precursor solution, based on the total weight of the first zeolite precursor solution. For example, and without limitation, the first zeolite precursor solution may include the silica source material in an amount, based on the total weight of the first zeolite precursor solution, from 20 wt. % to 30 wt. %, from 30 wt. % to 40 wt. %, from 40 wt. % to 50 wt. %, or any and all sub-ranges formed from any of these endpoints.

In one or more embodiments, the first zeolite precursor solution may have a molar composition of 20-28 Na₂O: 1Al₂O₃: 10-22 SiO₂: 150-350 H₂O. Molar ratios of any two of these components are contemplated herein based on the described molar ratio of Na₂O, alumina, silica, and water.

In one or more embodiments, the first zeolite precursor solution may be aged to form an aged first zeolite precursor solution. As described herein, aging may refer to heating the first zeolite precursor solution for a certain period of time. In embodiments, aging the first zeolite precursor solution includes keeping the first zeolite precursor static (e.g., no mixing occurs) during the aging process. The aging may be for a time period from 24 hours to 96 hours. For example, in one or more embodiments, aging may be for a time period of 24 hours to 36 hours, from 36 hours to 48 hours, from 48 hours to 60 hours, from 60 hours to 72 hours, from 72 hours to 84 hours, from 84 hours to 96 hours, or any and all sub-ranges formed from any of these endpoints. The aging may occur at a temperature from 15° C. to 45° C. For example, and without limitation, at least a portion of the aging may be carried out at an elevated temperature, for example, less than or equal to 45° C. or less than or equal to 35° C. In another example, and without limitation, at least a portion of the aging may be carried out at approximately ambient temperature, such as about 25° C. In still further examples, and without limitation, at least a portion of the aging may be carried out at a decreased temperature, such as less than 25° C. or even less than or equal to 20° C. In yet another example, and without limitation, the aging may be carried out at multiple temperatures and/or temperature ranges (e.g., a combination of an elevated temperature, ambient temperature, and a decreased temperature).

Without being bound by theory, while it is not believed that the overall chemical composition substantially changes in the mixture during aging, it is believed that aging may form zeolite nuclei or “seeds” from which zeolitic particles may be formed in downstream steps by crystallization. Accordingly, in embodiments, the first zeolite precursor solution may be referred to as a “seeding gel.” In general, final crystal and particle sizes may be smaller when more nuclei are formed during aging. Relatively small crystal and particle sizes may be desirable because they may decrease a diffusion path length and improve molecular diffusion of the zeolite, which may be advantageous to the catalytic activity of a catalyst including the zeolite.

According to one or more embodiments, following the formation of the first zeolite precursor solution, the second zeolite precursor solution is formed. As described herein, the first zeolite precursor solution is aged, while the second zeolite precursor solution is not aged, at least to the degree of the first zeolite precursor solution. In one or more embodiments, the second zeolite precursor solution may be prepared by mixing a basic compound into the solvent to form a basic mixture. Without limitation, the basic compound may be chosen from one or more of NaOH, KOH, Mg(OH)₂; however, the basic compound composition is not necessarily limited to the listed compounds. The alumina source material may be added to the basic mixture to form a second intermediate alumina mixture. The silica source material may be added to the second intermediate alumina mixture. The combined mixture of the silica source material and the second intermediate alumina mixture may be mixed until the silica source material dissolves, thereby forming the second zeolite precursor solution.

In one or more embodiments, the basic compound may comprise less than or equal to 5 wt. % of the second zeolite precursor solution, based on the total weight of the second zeolite precursor solution. For example, and without limitation, the second zeolite precursor solution may include the basic compound in an amount, based on the total weight of the second zeolite precursor solution, less than or equal to 3 wt. %, or even less than or equal to 1 wt. %.

In one or more embodiments, the solvent may comprise from 30 wt. % to 50 wt. % of the second zeolite precursor solution, based on the total weight of the second zeolite precursor solution. For example, and without limitation, the second zeolite precursor solution may include the solvent in an amount, based on the total weight of the second zeolite precursor solution, from 30 wt. % to 40 wt. %, from 40 wt. % to 50 wt. %, or any and all sub-ranges formed from any of these endpoints.

In one or more embodiments, the alumina source material may comprise from 1 wt. % to 10 wt. % of the second zeolite precursor solution, based on the total weight of the second zeolite precursor solution. For example, and without limitation, the second zeolite precursor solution may include the alumina source material in an amount, based on the total weight of the second zeolite precursor solution, from 1 wt. % to 3 wt. %, from 3 wt. % to 6 wt. %, from 6 wt. % to 10 wt. %, or any and all sub-ranges formed from any of these endpoints.

In one or more embodiments, the silica source material may comprise from 40 wt. % to 70 wt. % of the second zeolite precursor solution, based on the total weight of the second zeolite precursor solution. For example, and without limitation, the second zeolite precursor solution may include the silica source in an amount, based on the total weight of the second zeolite precursor solution, from 40 wt. % to 50 wt. %, from 50 wt. % to 60 wt. %, from 60 wt. % to 70 wt. %, or any and all sub-ranges formed from any of these endpoints.

In one or more embodiments, the second zeolite precursor solution may have a molar composition of 19-25 Na₂O: 1Al₂O₃: 10-22 SiO₂: 50-150 H₂O. Molar ratios of any two of these components are contemplated herein based on the described molar ratio of Na₂O, alumina, silica, and water.

In one or more embodiments, the third zeolite precursor solution may be prepared by combining the aged first zeolite precursor solution with the second zeolite precursor solution and mixing the combined solution to form a first intermediate mixture. In one or more embodiments, the combined solution may be mixed for a time period from 5 minutes to 60 minutes. For example, and without limitation, the combined solution may be mixed for a time period from 5 minutes to 15 minutes, from 15 minutes to 30 minutes, from 30 minutes to 45 minutes, from 45 minutes to 60 minutes, or any and all sub-ranges formed from any of these endpoints. In one or more embodiments, the second zeolite precursor solution is not aged prior to being combined with the first zeolite precursor solution. For example, the second zeolite precursor solution is not aged, such that the alumina source material, the silica source material, and the solvent in the second zeolite precursor solution are not all in contact with one another for more than 24 hours before being combined with the aged first zeolite precursor solution.

In one or more embodiments, a surfactant agent may be added to the first intermediate mixture to form a second intermediate mixture. In one or more embodiments, the second intermediate mixture may include from 0.5 moles to 5 moles of the surfactant agent. For example, and without limitation, the second intermediate mixture may include the surfactant agent in an amount from 0.5 moles to 1 mole, from 1 mole to 3 moles, from 3 moles to 5 moles, or any and all sub-ranges formed from any of these endpoints. Without limitation, the surfactant agent may be cetyltrimethylammonium bromide (CTAB).

In one or more embodiments, the second intermediate mixture may be mixed to form a third intermediate mixture. In one or more embodiments, the second intermediate mixture may be mixed for a time period from 5 minutes to 60 minutes. For example, and without limitation, the second intermediate mixture may be mixed for a time period from 5 minutes to 15 minutes, from 15 minutes to 30 minutes, from 30 minutes to 45 minutes, from 45 minutes to 60 minutes, or any and all sub-ranges formed from any of these endpoints.

In one or more embodiments, the third intermediate mixture may be heated in a heating step to form the zeolite-Y. In one or more embodiments, the heating step can include heating the third intermediate mixture at a temperature from 50° C. to 150° C. For example, and without limitation, the heating step can include heating the third intermediate mixture at a temperature from 50° C. to 100° C., from 100° C. to 150° C., or any and all sub-ranges formed from any of these endpoints. In one or more embodiments, the heating step can include heating the third intermediate mixture for a time period from 80 hours to 160 hours. For example, and without limitation, the heating step can include heating the third intermediate mixture for a time period, from 80 hours to 100 hours, from 100 hours to 120 hours, from 120 hours to 140 hours, from 140 hours to 160 hours, or any and all sub-ranges formed from any of these endpoints.

In one or more embodiments, the zeolite-Y may have a molar ratio of the silica source material to the alumina source material of from 4:6 to 5:6. For example, and without limitation, the zeolite-Y may have a molar ratio of the silica source material to the alumina source material from 4.5:6.

In one or more embodiments, the zeolite-Y may be filtered and washed. Filtering may be by any suitable filtering means, such as centrifuge, sieve, etc. The zeolite-Y may be washed with water. In one or more embodiments, the zeolite-Y may be washed until the pH value of the zeolite-Y is from about 8 to 9. The washed zeolite-Y may then be dried. In one or more embodiments, the zeolite-Y is dried at a temperature from 100° C. to 150° C. For example, and without limitation, the zeolite-Y is dried at a temperature from 100° C. to 125° C., from 125° C. to 150° C., or any and all sub-ranges formed from any of these endpoints. In one or more embodiments, the zeolite-Y is dried for a time period from 12 hours to 24 hours. For example, and without limitation, the zeolite-Y is dried for a time period from 12 hours to 18 hours, from 18 hours to 24 hours, or any and all sub-ranges formed from any of these endpoints. The dried zeolite-Y may be calcinated to form a final zeolite-Y product. The dried zeolite-Y may be calcinated at a temperature from 450° to 550° C. For example, and without limitation, the dried zeolite-Y is calcinated at a temperature from 450° C. to 500° C., from 500° C. to 550° C., or any and all sub-ranges formed from any of these endpoints. The dried zeolite-Y may be calcinated for a time period from 2 hours to 6 hours. For example, and without limitation, the dried zeolite-Y is calcinated for a time period from 2 hours to 4 hours, from 4 hours to 6 hours, or any and all sub-ranges formed from any of these endpoints.

As described herein, the zeolite-Y may be formed as particles. The particles may be shaped particles, such as spheres, or may be inconsistent in shape or otherwise globular in shape, and the shape of the particles is not necessarily limited in embodiments described herein. As used in the present disclosure, “particle size” refers to an average particle size and may be measured as the greatest distance between two points located on a single zeolite-Y particle. For example, the particle size of a spherical particle is equal to its diameter. In other shapes, the particle size is measured as the distance between the two most distant points of the same particle, where these points may lie on the outer surfaces of the particle. Particle size can be determined using Scanning Electron Microscopy (“SEM”), where the particle size is measured as the longest distance in any dimension of a particle. For example, in one or more embodiments, the zeolite-Y may have an average particle size less than or equal to 400 nm (nanometers), less than or equal to 350 nm, less than or equal to 300 nm, less than or equal to 250 nm, or even less than or equal to 200 nm, or any and all sub-ranges formed from any of these endpoints.

In one or more embodiments, the zeolite-Y particles described herein may include mesopores in addition to micropores (present in the microstructure of a zeolite). The zeolite-Y particles formed according to the methods described herein may be mesoporous. As used herein, “mesoporous” zeolite-Y may refer to zeolite-Y having an average pore size from 2 nm to 50 nm. Unless otherwise described herein, the “pore size” of a material refers to the average pore size, but materials may additionally include mesopores having a particular size that is not identical to the average pore size. The average pore size of a material can be measured using BET analysis, as is widely understood by those in the art. According to one or more embodiments, the zeolite-Y may have an average pore size greater than or equal to 5 nm, greater than or equal to 6 nm, greater than or equal to 7 nm, greater than or equal to 8 nm, or even greater than or equal to 10 nm.

In one or more embodiments, the zeolite-Y may have an average micropore volume and/or an average mesopore volume, where a total pore volume is the sum of these two. The mesopore and micropore volumes may be calculated according to the Barrett-Joiner-Halenda (BJH) method of determining mesopore volume known to one having skill in the art. Details regarding the t-plot method and the BJH method of calculating micropore volume and mesopore volume respectively are provided in Galarneau et al., “Validity of the t-plot Method to Assess Microporosity in Hierarchical Micro/Mesoporous Materials”, Langmuir 2014, 30, 13266-13274, for example. In one or more embodiments, the zeolite-Y may have a micropore volume less than or equal to 0.5 ml/g (milliliters per gram), less than or equal to 0.3 ml/g, less than or equal to 0.1 ml/g, or even less than or equal to 0.05, ml/g. In one or more embodiments, the zeolite-Y may have a mesopore volume greater than or equal to 0.5 ml/g, greater than or equal to 1.0 ml/g, or even greater than or equal to 1.5 ml/g. In one or more embodiments, the zeolite-Y may have a total pore volume greater than or equal to 0.8 ml/g, greater than or equal to 1.0 ml/g, greater than or equal to 1.2 ml/gm, or even greater than or equal to 1.4 ml/g.

In one or more embodiments, the zeolite-Y may have an average micropore surface area and/or an average mesopore surface area, where an average total surface area is the sum of these two. The micropore and mesopore surface area may be measured by Brunauer-Emmett-Teller (BET) analysis, as is known by those skilled in the art. In one or more embodiments, the zeolite-Y may have an average total surface area greater than or equal to 500 m²/g. Without being bound by theory, it is believed that a relatively high average total surface area of the zeolite-Y may increase the catalytic effectiveness of the zeolite-Y and/or zeolite-Y-containing catalyst, which is generally desirable. For example, in one or more embodiments, the zeolite-Y may have an average total surface area greater than or equal to 550 m²/g, greater than or equal to 600 m²/g, greater than or equal to 650 m²/g, greater than or equal to 700 m²/g, or even greater than or equal to 750 m²/g.

In one or more embodiments, the zeolite-Y may have a ratio of the mesopore surface to the average total surface area of at least 50%, at least 60%, at least 70%, at least 80%, at least 90%, or even at least 95%. Without being bound by theory, it is believed that a relatively high ratio of the mesopore surface area to the average total surface area (e.g., greater than or equal to 30%) may enhance the diffusion of large molecules inside the zeolite structure due to larger accessible active sites and quick and easy mass transfer.

As described herein, crystallinity is a measurement of the degree of structural order in a solid. A more crystalline solid will have its atoms and molecules arranged in a more regular and periodic manner than a less crystalline solid. Crystallinity is typically determined by x-ray diffraction. A particular diffraction peak can be selected, and its intensity normalized. Zeolites can be analyzed, and the diffraction intensity can be normalized against the standard, producing a relative crystallinity based on a standard zeolite structure. In one or more embodiments, the zeolite-Y particles may have a relative crystallinity based on the crystallinity of CBV-100, available from Zeolyst International, greater than or equal to 60%, greater than or equal to 70%, greater than or equal to 80%, or even greater than or equal to 90%.

The zeolite-Y formed according to the methods described herein may be utilized alone or in combination with other materials as catalysts used in hydrocracking processes. Such a catalyst may have at least two functions: cracking of high molecular weight hydrocarbon and hydrogenating the unsaturated molecules.

Zeolite-Y formed from conventional methods may not have desirable properties and, therefore, may have poor performance when utilized alone or in combination with other materials as catalysts used in hydrocracking processes. However, the zeolite-Y formed according to the methods described herein may have improved catalytic performance compared to conventional zeolite-Y because the zeolite-Y of the present disclosure has a relatively high mesoporosity (e.g., a total pore volume greater than or equal to 0.8 mL/g and/or a ratio of a mesopore surface area to a total surface area of at least 50%), a relatively large average pore size (e.g., greater than or equal to 5 nm), and a relatively small particle size (e.g., less than or equal to 400 nm). The relatively large pore size and relatively high mesoporosity of the zeolite-Y of the present disclosure may favor the transport of large molecules in heavy oil fractions to diffuse into the active sites located inside the zeolite. Further, the relatively small particle size of the presently disclosed zeolite-Y may enable better access of reactive molecules to catalytic sites of the zeolite-Y. Thus, the zeolite-Y described herein may have improved hydrothermal stability and desirable catalytic activity and selectivity.

### EXAMPLES

Examples are provided herein, which may disclose one or more embodiments of the present disclosure. However, the Examples should not be viewed as limiting on the claimed embodiments hereinafter provided.

### Example 1 (EX-1)—Production of Zeolite-Y

To form a first zeolite precursor solution, a first intermediate alumina mixture was formed by combining 4.995 grams (g) of H₂O, 0.407 g of NaOH, and 0.209 g of NaAlO₂ in a plastic bottle and stirring until the mixture was dissolved. To the first intermediate alumina mixture, 2.83 g of Na₂SiO₃ was added, and the resulting second mixture was stirred for about 10 minutes until the Na₂SiO₃ dissolved. This second mixture was aged at room temperature (e.g., approximately 23° C.) for 48 hours to form the first zeolite precursor solution.

To form a second zeolite precursor solution, a basic mixture was formed by combining 43.67 g of H₂O with 0.05 g of NaOH in a plastic bottle and stirring until the mixture was dissolved. To this basic mixture, 4.3 g of NaAlO₂ was added to form a second intermediate alumina mixture. The second intermediate alumina mixture was stirred until the NaAlO₂ was dissolved. To the second intermediate alumina mixture, 59.3 g of Na₂SiO₃ was added, and the mixture was stirred to form the second zeolite precursor solution.

To form a third zeolite precursor solution, 5.5 g of the first zeolite precursor solution was added to the second zeolite precursor solution in a plastic bottle and stirred for 20 minutes to form a first intermediate mixture. To the first intermediate mixture, 30 milliliters (ml) of a 2.5 molar CTAB stock solution (e.g., 27.3 g of CTAB dissolved in 30 ml of water) was added, and the resulting second intermediate mixture was stirred for 20 minutes. The bottle containing the second intermediate mixture was transferred to an oven and heated at 95° C. for 5 days (e.g., approximately 120 hours) to form a product. The product was then filtrated and washed with water until its pH value was between 7 and 9. The resulting solid product was subsequently dried at 110° C. for 24 hours and then calcinated at 500° C. for 4 hours (2° C./min ramp) to form zeolite-Y particles.

### Comparative Example 1 (CE-1)—Production of Comparative Zeolite-Y

First 6.8 g of NaOH was stirred and dissolved in 39.24 g of water in a glass bottle and then allowed to cool. To this mixture, 1.64 g of NaAlO₂ and 21.0 g of 40 wt. % colloidal silica was added and stirred for 1 hour. The mixture was then stirred and aged at 30° C. for 20 hours. The resulting hydrogel mixture was next autoclaved at 60° C. for 12 hours. Then, the colloidal product mixture was cooled to room temperature and set aside. Following this process, 5.0 g of CTAB along with 1.0 g of NaOH, 0.83 g of 1,2,4-trimethybenzene (TMB) as a swelling agent, 10.0 mL of ethyl alcohol as a cosolvent, 10.00 g of TEOS, and 20.0 g of distilled water were added to a separate beaker and mixed for 30 minutes. This resulting product was then mixed with the colloidal product that had been set aside and mixed for 30 minutes. The resulting hydrogel mixture was then crystallized at 100° C. for 12 hours. The product was then filtrated and washed with water until its pH reached between 8 and 9. The resulting solid product was subsequently dried at 110° C. for 24 hours and then calcinated at 500° C. for 4 hours (2° C./min ramp) to form zeolite-Y particles.

### Comparative Example 2 (CE-2)—Production of Comparative Zeolite-Y

First 6.8 g of sodium hydroxide (NaOH) was stirred and dissolved in 39.24 g of water in a glass bottle and then allowed to cool. To this mixture 1.64 g of sodium aluminate (NaAlO₂) and 21.00 g of 40 wt. % colloidal silica was added and stirred for 1 hour. The mixture was then stirred and aged at 30° C. for 20 hours. The resulting hydrogel mixture was next autoclaved at 60° C. for 12 hours. Then, the colloidal product mixture was cooled to room temperature and set aside. Following this process, 5.0 g of CTAB along with 1.0 g of NaOH, 10.0 mL of ethyl alcohol as a cosolvent, 10.0 g of TEOS, and 20.00 g of distilled water were added to a separate beaker and mixed for 30 minutes. This resulting product was then mixed with the colloidal product that had been set aside and mixed for 30 minutes. The resulting hydrogel mixture was then crystallized at 100° C. for 12 hours. The product was then filtrated and washed with water until its pH reached between 8 and 9. The resulting solid product was subsequently dried at 110° C. for 24 hours and then calcinated at 500° C. for 4 hours (2° C./min ramp).

### Example 3—Characterization of Zeolites of Examples 1 and 2

The properties of the zeolite-Y particles formed according to EX- and 1 CE-1 are provided in Table 1.

TABLE 1
Main Properties of CE-1 and EX-1

| Property | Unit of Measure | EX-1 | CE-1 | CE-2 |
|---|---|---|---|---|
| Average particle size | Nanometers (nm) | 200 | 290 | 437 |
| Crystallinity | Percent (%) | 75 | 63 | 69 |
| Bulk Si/Al | Mol/Mol ratio | 2.3 | 2.6 | 2.6 |
| Total surface area | Square meters per gram (m²/g) | 676 | 681 | 631 |
| Micropore surface area | m²/g | 36 | 416 | 401 |
| Mesopore surface area | m²/g | 640 | 265 | 230 |
| Total pore volume | Millitlers per gram (mL/g) | 1.20 | 0.50 | 0.44 |
| Micropore volume | mL/g | 0.02 | 0.23 | 0.23 |
| Mesopore volume | mL/g | 1.22 | 0.27 | 0.21 |
| Pore size | nm | 7.0 | 2.9 | 2.8 |

As shown in Table 1, the zeolite-Y of EX-1 formed according to the methods described herein has a relatively high mesoporosity compared to comparative examples CE-1 and CE-2. In particular, EX-1 has a total pore volume of 1.2, whereas CE-1 has a total pore volume of only 0.50 ml/g and CE-2 has a total pore volume of 0.44 ml/g. Additionally, a greater percentage of the total surface area of the zeolite-Y of EX-1 is attributed to mesopores compared to the conventionally formed zeolite-Y particles of CE-1 and CE-2. Indeed, greater than 94% (e.g., mesopore surface area/total surface area) of the surface area of the zeolite-Y of EX-1 is attributed to mesopores. Whereas, less than 40% of the surface area of CE-1 and less than 37% of the surface area of CE-2 are attributed to mesopores. Accordingly, the zeolite-Y particles of CE-1 and CE-2 are primarily microporous. As discussed herein, the relatively high mesoporosity of the zeolite-y of EX-1 may favor the transport of large molecules in heavy oil fractions to diffuse into the active sites located inside the zeolite. Thus, the zeolite-Y of EX-1 may have improved catalytic activity and selectivity compared to conventionally formed zeolite-Y, such as the zeolite-Y particles of CE-1 and CE-2.

Further, the zeolite-Y of EX-1 has improved crystallinity (e.g., 75%) as compared to the zeolite-Y particles of CE-1 (e.g., 63%) and CE-2 (e.g., 69%). The relatively high crystallinity of the zeolite-Y of EX-1 may promote a more uniform pore structure within the zeolite-Y and result in improved hydrothermal stability and desirable catalytic activity and selectivity.

Moreover, the zeolite-Y of EX-1 has a relatively small particle size of 200 nm compared to the zeolite-Y of CE-1 (e.g., 290 nm) and CE-2 (e.g., 437 nm). As discussed herein, a relatively small particle size may be desirable because it may decrease a diffusion path length and improve molecular diffusion of the zeolite, which may contribute to a desirable catalytic activity. Thus, the zeolite-Y of EX-1 may have improved catalytic activity compared to the conventional formed zeolite-Y particles of CE-1 and CE-2.

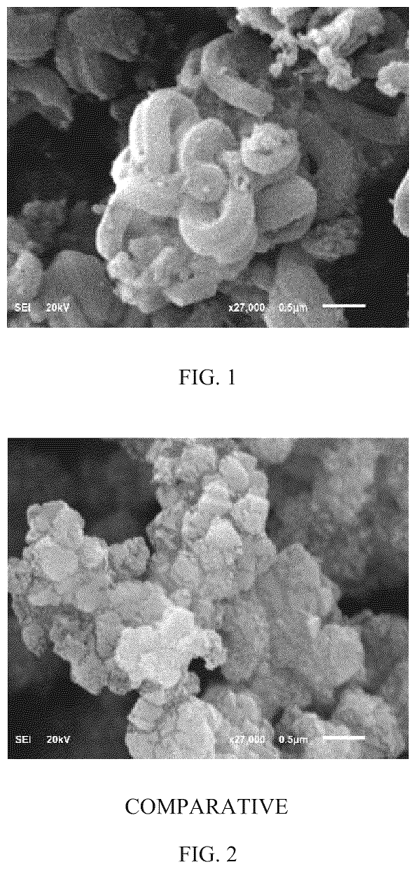

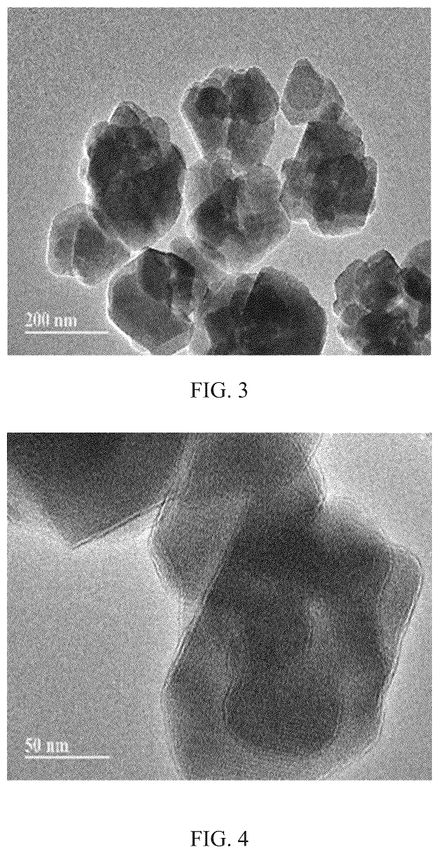

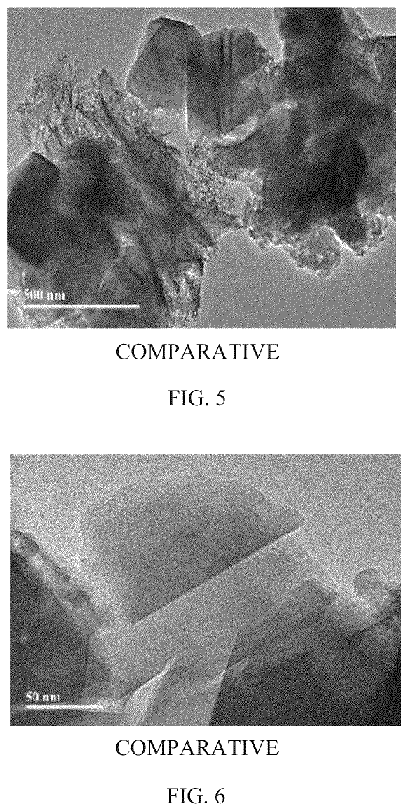

Accordingly, the method of forming the zeolite-Y of EX-1, including forming an aged first zeolite precursor solution, forming a second zeolite precursor solution, and forming a third zeolite precursor solution by combining the aged first and second zeolite precursor solutions, may lead to desired physical properties of the synthesized zeolite-Y particles formed therefrom. These aspects are further illustrated in FIGS. 1 and 2, which are Scanning Electron Microscopy (SEM) analysis images that show the improved surface properties of the zeolite-Y of EX-1 (e.g., FIG. 1) compared to CE-1 (e.g., FIG. 2) and FIGS. 3-6, which are Transmission electron microscopy (TEM) analysis images that show the improved crystallinity of EX-1 (e.g., FIGS. 3 and 4) compared to CE-1 (e.g., FIGS. 5 and 6).

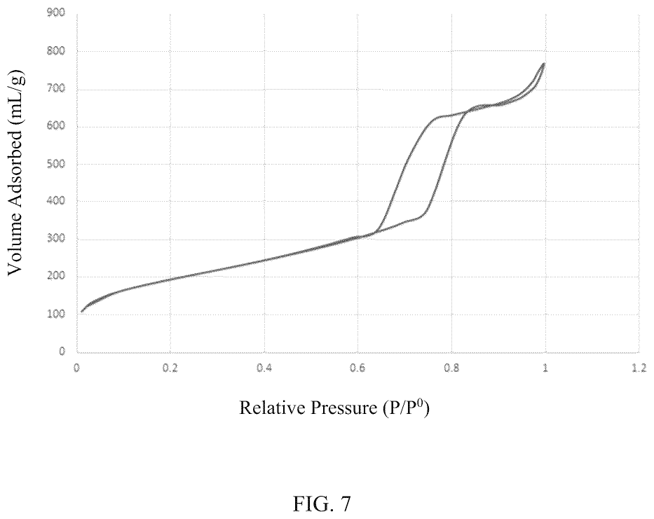

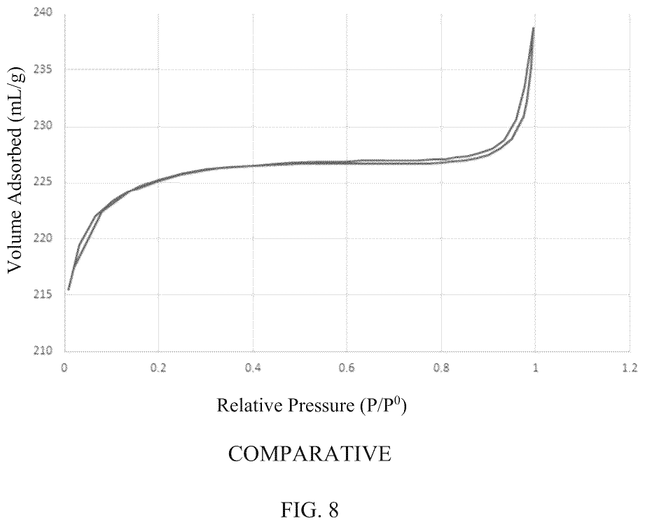

Moreover, FIGS. 7 and 8 demonstrate that the zeolite-Y of EX-1 may have improved catalytic activity compared to the zeolite-Y of CE-1, as evidenced by their respective isotherm plots. Specifically, FIG. 7 is an N₂ physisorption analysis isotherm plot of the zeolite-Y of EX-1 and FIG. 8 is an N₂ physisorption analysis isotherm plot of the zeolite-Y of CE-1. Comparing the isotherm plots of FIG. 7 and FIG. 8, it can be seen that the zeolite-Y of EX-1 has a much greater adsorption volume (e.g., up to almost 800 mL/g) than the zeolite-Y of CE-1 (e.g., less than 240 mL/g). As discussed herein, the relatively high mesoporosity of the zeolite-Y of EX-1 may result in a zeolite-Y having enhanced diffusion and selectivity, which is evidenced by the high adsorption volume of the zeolite-Y of EX-1.

Based on the foregoing, it should now be understood that the methods of forming zeolite-Y may allow for the formation of zeolite-Y with superior properties as compared with zeolite-Y formed through conventional methods.

This disclosure includes numerous aspects. A first aspect is directed to a method of forming zeolite-Y, the method comprising: forming a first zeolite precursor solution comprising an alumina source material, a silica source material, and a solvent; aging the first zeolite precursor solution at a temperature from 15° C. to 45° C. for a time period of from 24 hours to 96 hours to form an aged first zeolite precursor solution; forming a second zeolite precursor solution comprising the alumina source material, the silica source material, and the solvent, forming a third zeolite precursor solution comprising the aged first zeolite precursor solution and the second zeolite precursor solution, wherein the second zeolite precursor solution is not aged such that the alumina source material, the silica source material, and the solvent in the second zeolite precursor solution are not all in contact with one another for more than 24 hours before being combined with the aged first zeolite precursor solution; mixing the third zeolite precursor solution for a time period from 5 minutes to 60 minutes to form a first intermediate mixture; adding a surfactant agent to the first intermediate mixture to form a second intermediate mixture; mixing the second intermediate mixture for a time period from 5 minutes to 60 minutes to form a third intermediate mixture; and heating the third intermediate mixture at a temperature from 50° C. to 150° C. for a time period from 80 hours to 160 hours to form the zeolite-Y.

A second aspect includes the first aspect, wherein the first zeolite precursor solution has a greater concentration of solvent than the second zeolite precursor solution.

A third aspect includes the first or second aspects, wherein the first zeolite precursor solution has a molar composition comprising 20-28 Na₂O: 1Al₂O₃: 10-22 SiO₂: 150-350 H₂O.

A fourth aspect includes any of the above aspects, wherein the second zeolite precursor solution has a molar composition comprising 19-25 Na₂O: 1Al₂O₃: 10-22 SiO₂: 50-150 H₂O.

A fifth aspect includes any of the above aspects, wherein: the first zeolite precursor solution has a molar composition comprising 20-28 Na₂O: 1Al₂O₃: 10-22 SiO₂: 150-350 H₂O; and the second zeolite precursor solution has a molar composition comprising 19-25 Na₂O: 1Al₂O₃: 10-22 SiO₂: 50-150 H₂O.

A seventh aspect includes any of the above aspects, wherein the second zeolite precursor solution is not aged such that the alumina source material, the silica source material, and the solvent in the second zeolite precursor solution are not all in contact with one another for more than 1 hour before being combined with the aged first zeolite precursor solution.

An eighth aspect includes any of the above aspects, wherein forming the first zeolite precursor solution comprises: forming a first intermediate alumina mixture comprising a basic compound, the alumina source material, and the solvent; and adding the silica source material to the first intermediate alumina mixture and mixing for a time period of at least 10 minutes to form the first zeolite precursor solution; wherein the first zeolite precursor solution has a molar composition comprising 20-28 Na₂O: 1Al₂O₃: 10-22 SiO₂: 150-350 H₂O.

A ninth aspect includes any of the above aspects, wherein forming the second zeolite precursor solution comprises: mixing a basic compound into the solvent to form a basic mixture; adding the alumina source material to the basic mixture to form a second intermediate alumina mixture; and adding the silica source material to the second intermediate alumina mixture to form the second zeolite precursor solution; wherein the second zeolite precursor solution has a molar composition comprising 19-25 Na₂O: 1Al₂O₃: 10-22 SiO₂: 50-150 H₂O.

A ninth aspect includes any of the above aspects, wherein the alumina source material comprises one or more of elemental aluminum, NaAlO₂, Al₂(SO₄)₃, Al(NO₃)₃, AlCl₃, Al₂O₃, C₉H₂₁O₃Al.

A tenth aspect includes any of the above aspects, wherein the silica source material comprises one or more of Na₂SiO₃, colloidal silica, fumed silica, and tetraethyl orthosilicate.

An eleventh aspect includes any of the above aspects, wherein the surfactant agent comprises cetyltrimethylammonium bromide.

A twelfth aspect includes any of the above aspects, wherein the second intermediate mixture comprises from 0.5 moles to 5 moles of the surfactant agent.

A thirteenth aspect includes any of the above aspects, further comprising: filtering and washing the zeolite-Y; drying the filtered and washed zeolite-Y at a temperature from 100° C. to 150° C. for a time period from 12 hours to 24 hours; and calcinating the dried zeolite-Y at a temperature from 450° C. to 550° C. for a time period of from 2 hours to 6 hours.

A fourteenth aspect includes any of the above aspects, wherein the zeolite-Y comprises a molar ratio of the silica source material to the alumina source material of from 4:6 to 5:6.

A fifteenth aspect includes any of the above aspects, wherein the zeolite-Y has an average particle size less than or equal to 400 nm.

A sixteenth aspect includes any of the above aspects, wherein the zeolite-Y has an average pore size greater than or equal to 5 nm.

A seventeenth aspect includes any of the above aspects, wherein the zeolite-Y has a total pore volume greater than or equal to 0.8 mL/g.

An eighteenth aspect includes any of the above aspects, wherein the zeolite-Y has an average total surface area greater than or equal to 500 m²/g.

A nineteenth aspect includes any of the above aspects, wherein the zeolite-Y has a ratio of a mesopore surface area to a total surface area of at least 50%.

A twentieth aspect include any of the above aspects, wherein the zeolite-Y has a crystallinity greater than or equal to 60%.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

For the purposes of describing and defining the present disclosure, it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation.

It should be understood that any two quantitative values assigned to a property may constitute a range of that property, and all combinations of ranges formed from all stated quantitative values of a given property are contemplated in this disclosure.

of a series of characteristics of the structure and should be interpreted in like manner as the more commonly used open-ended preamble term “comprising.” It should be understood that where a first component is described as “comprising” a second component, it is contemplated that, in some embodiments, the first component “consists” or “consists essentially of” that second component. The transitional phrase “consisting of” excludes any element, step, or ingredient not specified in the claim, and the transitional phrase “consisting essentially of” is a limitation to the specified materials or steps and those that do not materially affect the basic and novel characteristics of the claimed embodiment.

What is claimed is:

1. A method of forming zeolite-Y, the method comprising:
forming a first zeolite precursor solution comprising an alumina source material, a silica source material, and a solvent;
aging the first zeolite precursor solution at a temperature from 15° C. to 45° C. for a time period of from 24 hours to 96 hours to form an aged first zeolite precursor solution;
forming a second zeolite precursor solution comprising the alumina source material, the silica source material, and the solvent, forming a third zeolite precursor solution comprising the aged first zeolite precursor solution and the second zeolite precursor solution, wherein the second zeolite precursor solution is not aged such that the alumina source material, the silica source material, and the solvent in the second zeolite precursor solution are not all in contact with one another for more than 24 hours before being combined with the aged first zeolite precursor solution;
mixing the third zeolite precursor solution for a time period from 5 minutes to 60 minutes to form a first intermediate mixture;
adding a surfactant agent to the first intermediate mixture to form a second intermediate mixture;
mixing the second intermediate mixture for a time period from 5 minutes to 60 minutes to form a third intermediate mixture; and
heating the third intermediate mixture at a temperature from 50° C. to 150° C. for a time period from 80 hours to 160 hours to form the zeolite-Y.

2. The method of claim 1, wherein the first zeolite precursor solution has a greater concentration of solvent than the second zeolite precursor solution.

3. The method of claim 1, wherein the first zeolite precursor solution has a molar composition comprising 20-28 Na₂O: 1Al₂O₃: 10-22 SiO₂: 150-350 H₂O.

4. The method of claim 1, wherein the second zeolite precursor solution has a molar composition comprising 19-25 Na₂O: 1Al₂O₃: 10-22 SiO₂: 50-150 H₂O.

5. The method of claim 1, wherein:
the first zeolite precursor solution has a molar composition comprising 20-28 Na₂O: 1Al₂O₃: 10-22 SiO₂: 150-350 H₂O; and
the second zeolite precursor solution has a molar composition comprising 19-25 Na₂O: 1Al₂O₃: 10-22 SiO₂: 50-150 H₂O.

6. The method of claim 1, wherein the second zeolite precursor solution is not aged such that the alumina source material, the silica source material, and the solvent in the second zeolite precursor solution are not all in contact with one another for more than 1 hour before being combined with the aged first zeolite precursor solution.

7. The method of claim 1, wherein forming the first zeolite precursor solution comprises:
forming a first intermediate alumina mixture comprising a basic compound, the alumina source material, and the solvent; and
adding the silica source material to the first intermediate alumina mixture and mixing for a time period of at least 10 minutes to form the first zeolite precursor solution;
wherein the first zeolite precursor solution has a molar composition comprising 20-28 Na₂O: 1Al₂O₃: 10-22 SiO₂: 150-350 H₂O.

8. The method of claim 1, wherein forming the second zeolite precursor solution comprises:
mixing a basic compound into the solvent to form a basic mixture;
adding the alumina source material to the basic mixture to form a second intermediate alumina mixture; and
adding the silica source material to the second intermediate alumina mixture to form the second zeolite precursor solution;
wherein the second zeolite precursor solution has a molar composition comprising 19-25 Na₂O: 1Al₂O₃: 10-22 SiO₂: 50-150 H₂O.

9. The method of claim 1, wherein the alumina source material comprises one or more of elemental aluminum, NaAlO₂, Al₂(SO₄)³, Al(NO₃)₃, AlCl₃, Al₂O₃, C₉H₂₁O₃Al.

10. The method of claim 1, wherein the silica source material comprises one or more of Na₂SiO₃, colloidal silica, fumed silica, and tetraethyl orthosilicate.

11. The method of claim 1, wherein the surfactant agent comprises cetyltrimethylammonium bromide.

12. The method of claim 1, wherein the second intermediate mixture comprises from 0.5 moles to 5 moles of the surfactant agent.

13. The method of claim 1, further comprising:
filtering and washing the zeolite-Y;
drying the filtered and washed zeolite-Y at a temperature from 100° C. to 150° C. for a time period from 12 hours to 24 hours; and
calcinating the dried zeolite-Y at a temperature from 450° C. to 550° C. for a time period of from 2 hours to 6 hours.

14. The method of claim 1, wherein the zeolite-Y comprises a molar ratio of the silica source material to the alumina source material of from 4:6 to 5:6.

15. The method of claim 1, wherein the zeolite-Y has an average particle size less than or equal to 400 nm.

16. The method of claim 1, wherein the zeolite-Y has an average pore size greater than or equal to 5 nm.

17. The method of claim 1, wherein the zeolite-Y has a total pore volume greater than or equal to 0.8 mL/g.

18. The method of claim 1, wherein the zeolite-Y has an average total surface area greater than or equal to 500 m²/g.

19. The method of claim 1, wherein the zeolite-Y has a ratio of a mesopore surface area to a total surface area of at least 50%.

20. The method of claim 1, wherein the zeolite-Y has a crystallinity greater than or equal to 60%.
